(19) United States
(12) Patent Application Publication
(10) Pub. No.: US 2009/0153995 A1
(43) Pub. Date: Jun. 18, 2009

(54) Temperature coefficient of resistance measurement of TMR head using flying height control heater and determine maximum bias voltage of TMR heads

(75) Inventor: Eunkyu Jang, San Jose, CA (US)

Correspondence Address: IRELL & MANELLA LLP, 840 NEWPORT CENTER DRIVE, SUITE 400, NEWPORT BEACH, CA, 92660, US

(73) Assignee: Samsung Electronics Co., Ltd., Suwon City (KR)

(21) Appl. No.: 12/001,885

(22) Filed: Dec. 12, 2007

(51) Int. Cl. G11B 27/36

(52) U.S. Cl. 360/31

(57) ABSTRACT

A method for determining whether a magneto-resistive head of a hard disk drive is defective for having an undesirable break down voltage. The method includes applying a voltage to a heater element of a magneto-resistive head and measuring a write element resistance and a read element resistance. A temperature coefficient of resistance for the read element is determined from the measured read and write element resistances. The head is considered defective if the temperature coefficient exceeds a threshold.

### BACKGROUND OF THE INVENTION

1. Field of the Invention

The present invention relates to determining a break down voltage and an optimal read bias voltage for a magneto-resistive head of a hard disk drive.

2. Background Information

Hard disk drives contain a plurality of magnetic heads that are coupled to rotating disks. The heads write and read information by magnetizing and sensing the magnetic fields of the disk surfaces. Each head is attached to a flexure arm to create a subassembly commonly referred to as a head gimbal assembly (“HGA”). The HGA's are suspended from an actuator arm. The actuator arm has a voice coil motor that can move the heads across the surfaces of the disks.

The disks are rotated by a spindle motor of the drive. Rotation of the disks creates an air flow within the disk drive. Each head has an air bearing surface that cooperates with the air flow to create an air bearing between the head and the adjacent disk surface. The air bearing eliminates or minimizes the mechanical wear between the head and the disk. The height of the air bearing is commonly referred to as the flying height of the head.

The magnetic field detected by the head is inversely proportional to the flying height of the head. Likewise, the strength of the magnetic field written onto the disk is inversely proportional to the fly height. A larger fly height will produce a weaker magnetic field on the disk.

There have been developed heads that include a heater element. Current is provided to the heater element to generate heat and thermally expand the head to move the read and write elements closer to the disk. These types of heads are sometimes referred to as fly on demand (“FOD”) heads. The flying height of FOD heads can be varied by changing the amount of power provided to the heater element.

The heads typically have a write element to magnetize and write data on a disk and a separate read element to sense the magnetic field and read a disk. The read element is typically constructed from a magneto-resistive material that has a linear relationship between a magnetic field and the resistance of the material. These types of heads are commonly referred to as magneto-resistive (“MR”) heads. There are typically two types of MR heads, giant magneto-resistive (“GMR”) and tunneling magneto-resistive (“TMR”). TMR heads are preferred because of their relatively high ΔR/R characteristics.

The read element of an MR head is biased with a biasing voltage. The biasing voltage must be less than the breakdown voltage of the device. TMR heads have ultra thin barrier layers that are susceptible to pinholes. The existence of pinholes in the barrier layer can lead to excessive heat concentration that causes the head to fail. This phenomena is excaberated at elevated head temperatures. One way to determine the break down voltage at elevated temperatures is to place the head in an oven, or heating the head by providing electrical current to the write coil. Such an approach requires temperature sensors and other external equipment. Another approach involves the destruction of the head. It would be desirable to screen TMR heads to determine acceptable breakdown voltages without extraneous equipment or by destroying the heads.

### BRIEF SUMMARY OF THE INVENTION

A method for determining whether a magneto-resistive head of a hard disk drive is defective for having an undesirable break down voltage. The method includes applying a voltage to a heater element of a magneto-resistive head and measuring a write element resistance and a read element resistance. A temperature coefficient of resistance for the read element is determined from the measured read and write element resistances. The head is considered defective if the temperature coefficient exceeds a threshold.

### BRIEF DESCRIPTION OF THE DRAWINGS

FIG. 1 is a top view of an embodiment of a hard disk drive;

FIG. 2 is an illustration of a head of the hard disk drive;

FIG. 3 is a schematic of an electrical circuit for the hard disk drive;

FIG. 4 is a flowchart showing a method for determining a break down voltage;

FIG. 5 is a graph showing a correlation between a temperature coefficient of resistance and break down voltage;

FIG. 6 is a flowchart showing a method for determining an optimal read bias voltage.

### DETAILED DESCRIPTION

A method for determining whether a magneto-resistive head of a hard disk drive is defective for having an undesirable break down voltage. The method includes applying a voltage to a heater element of a magneto-resistive head and measuring a write element resistance and a read element resistance. A temperature coefficient of resistance for the read element is determined from the measured read and write element resistances. The head is considered defective if the temperature coefficient exceeds a threshold. The head is not destroyed and the process does not require an oven to heat the device. The heater element can also be used to heat the head to determine an optimal read bias voltage.

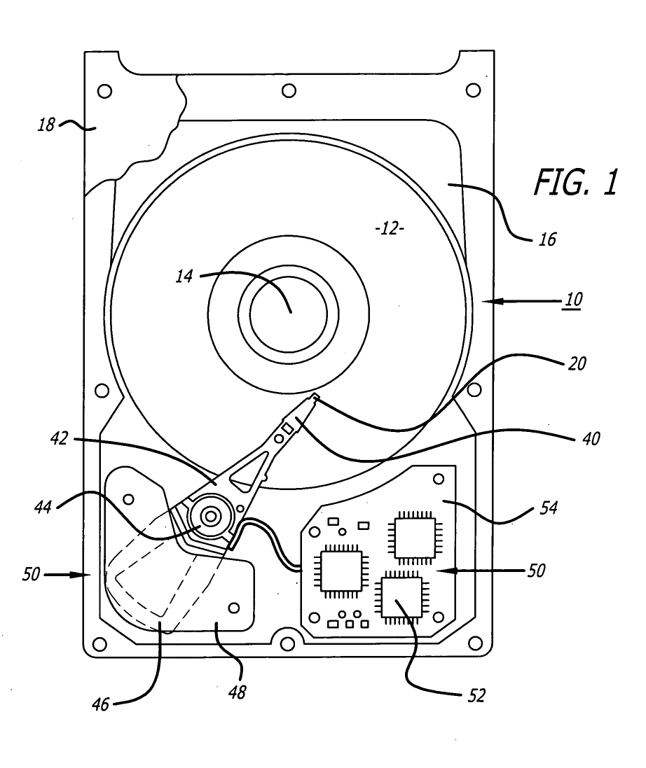

Referring to the drawings more particularly by reference numbers, FIG. 1 shows an embodiment of a hard disk drive 10 of the present invention. The disk drive 10 may include one or more magnetic disks 12 that are rotated by a spindle motor 14. The spindle motor 14 may be mounted to a base plate 16. The disk drive 10 may further have a cover 18 that encloses the disks 12.

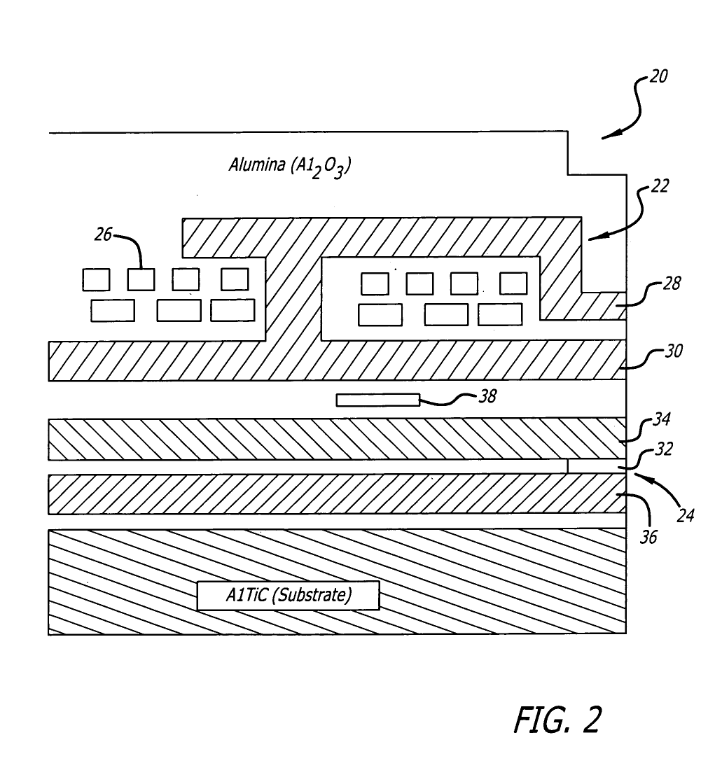

The disk drive 10 may include a plurality of heads 20 located adjacent to the disks 12. As shown in FIG. 2 each head 20 may have separate write 22 and read elements 24. The write element 22 typically includes a write coil 26 and a pair of magnetic poles 28 and 30. The write element 22 magnetizes the disk 12 to write data when a current is provided to the write coil 26. The read element 24 may include a magneto-resistive material 32 located between a pair of shields 34 and 36. The read element 24 senses the magnetic fields of the disks 12 to read data. The magneto-resistive material has a resistance which varies linearly with changes in magnetic flux. The head 20 may be a perpendicular recording head.

Each head also has a heater element 38. The heater element 38 may receive current that generates heat in the head. The heat causes the head to thermally expand and varies the fly height. Such heads are commonly referred to fly on demand (“FOD”) heads.

Referring to FIG. 1, each head 20 may be gimbal mounted to a flexure arm 40 as part of a head gimbal assembly (HGA). The flexure arms 40 are attached to an actuator arm 42 that is pivotally mounted to the base plate 16 by a bearing assembly 44. A voice coil 46 is attached to the actuator arm 42. The voice coil 46 is coupled to a magnet assembly 48 to create a voice coil motor (VCM) 50. Providing a current to the voice coil 46 will create a torque that swings the actuator arm 42 and moves the heads 20 across the disks 12.

The hard disk drive 10 may include a printed circuit board assembly 50 that includes a plurality of integrated circuits 52 coupled to a printed circuit board 54. The printed circuit board 52 is coupled to the voice coil 46, heads 20 and spindle motor 14 by wires (not shown).

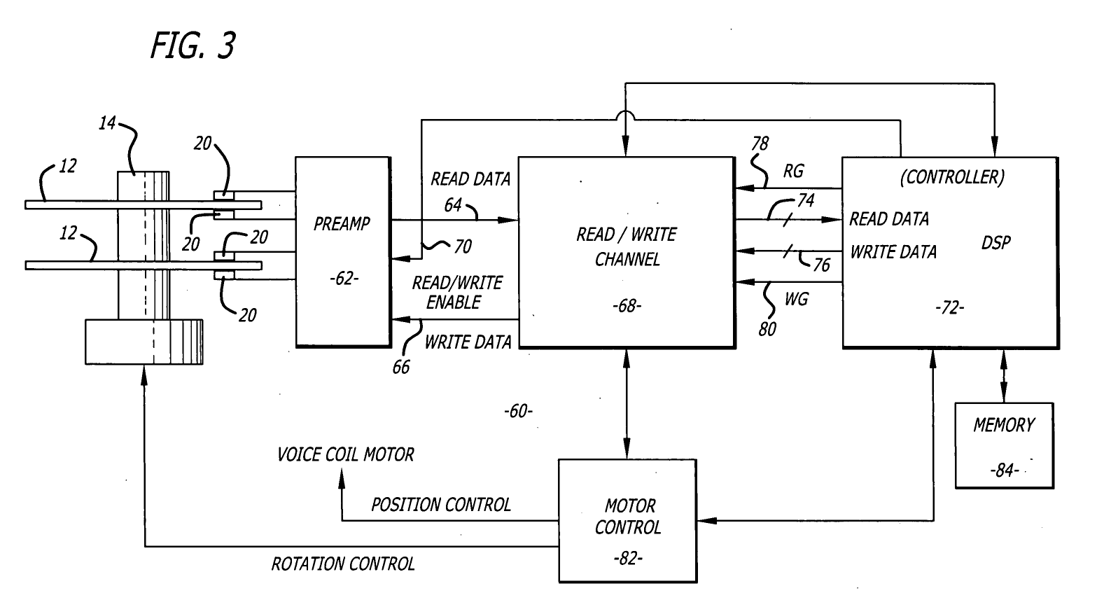

FIG. 3 shows an electrical circuit 60 for reading and writing data onto the disks 12. The circuit 60 may include a pre-amplifier circuit 62 that is coupled to the heads 20. The pre-amplifier circuit 62 has a read data channel 64 and a write data channel 66 that are connected to a read/write channel circuit 68. The pre-amplifier 62 also has a read/write enable gate 70 connected to a controller 72. Data can be written onto the disks 12, or read from the disks 12 by enabling the read/write enable gate 70.

The read/write channel circuit 68 is connected to a controller 72 through read and write channels 74 and 76, respectively, and read and write gates 78 and 80, respectively. The read gate 78 is enabled when data is to be read from the disks 12. The write gate 80 is to be enabled when writing data to the disks 12. The controller 72 may be a digital signal processor that operates in accordance with a software routine, including a routine(s) to write and read data from the disks 12. The read/write channel circuit 68 and controller 72 may also be connected to a motor control circuit 82 which controls the voice coil motor 48 and spindle motor 14 of the disk drive 10. The controller 72 may be connected to a non-volatile memory device 84. By way of example, the device 84 may be a read only memory (“ROM”). The non-volatile memory 84 may contain the instructions to operate the controller and disk drive. Alternatively, the controller 72 may have embedded firmware to operate the drive.

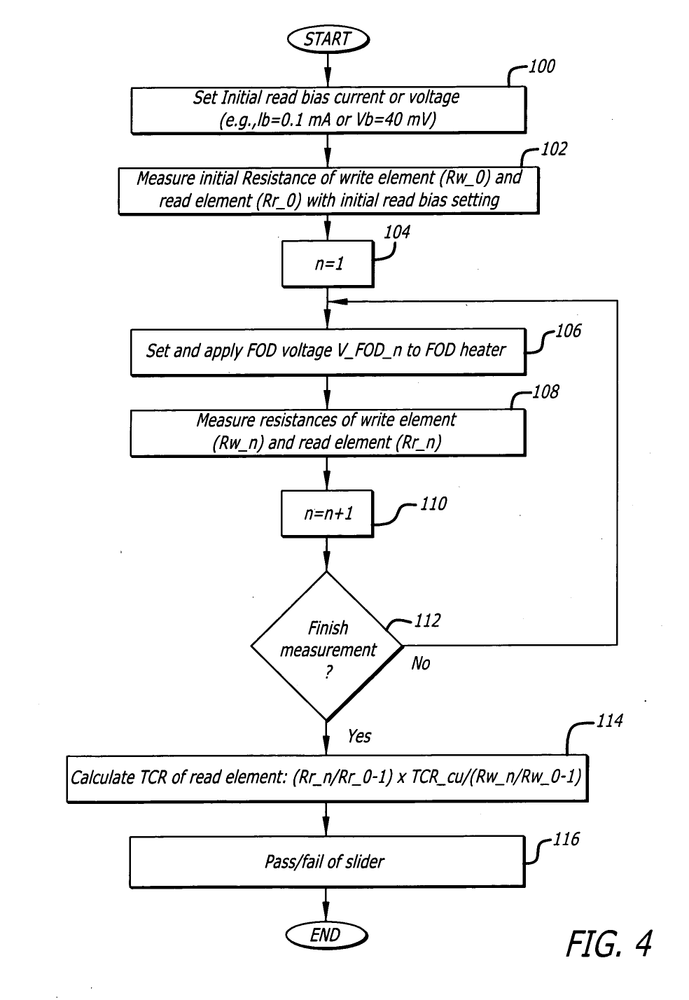

FIG. 4 is a flowchart showing a process to determine whether a head has an undesirable break down voltage. In step 100 an initial read bias current or voltage is set for the read element. The resistances of the read element and the write element are measured in step 102 and set as Rw_0 and Rr_0, respectively. In step 104 the iteration is set at 1.

In step 106, a voltage is applied to the heater element of the head. The resistances of the read element and write element are once again measured in step 108 and set as Rw_n and Rr_n, respectively. The iteration is increased in step 110. In decision block 112 it is determined whether the process has reached the final iteration. If not, the process returns to set 106. The voltage to the heater element is increased to raise the temperature and new resistance value are measured in steps 106 and 108, respectively. The polarity of the voltage provided to the heater element may also be reversed during the loop process to offset any magnetic effects on the write and read elements.

If the determination in decision block 112 is yes then the process proceeds to step 114 where the temperature coefficient of resistance for the read element TCR_r is determined with the following equation:

TCR_{—}r=(Rr_{—}n/Rr_{—}0−1)×TCR_{—}cu/(Rw_{—}n/Rw_{—}0−1) (1)

TCR_cu is the temperature coefficient of the write coil. If the write coil is constructed from copper the TCR_cu value is 0.39%/° C. If multiple Rw_n and Rr_n values are measured then a linear regression method can be used to determine the TCR of the read head.

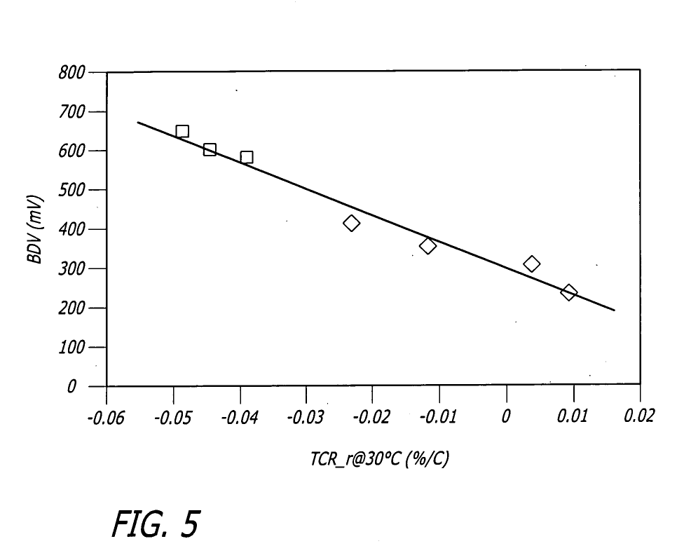

In step 116 the TCR_r is compared with a threshold value. If the TCR_r exceeds a threshold value the head can be deemed defective. By way of example, the threshold value may be −0.05%/deg. The TCR_r corresponds to break down voltage as shown by the graph in FIG. 5. The threshold TCR value can be set to correspond with an undesirable break down voltage. With the process described in FIG. 4, a head can be analyzed to determine whether it has an unacceptable break down voltage at elevated temperatures by using the heater element as a heat source. There is no need to place the head in an oven. Additionally, the process is not a destructive test.

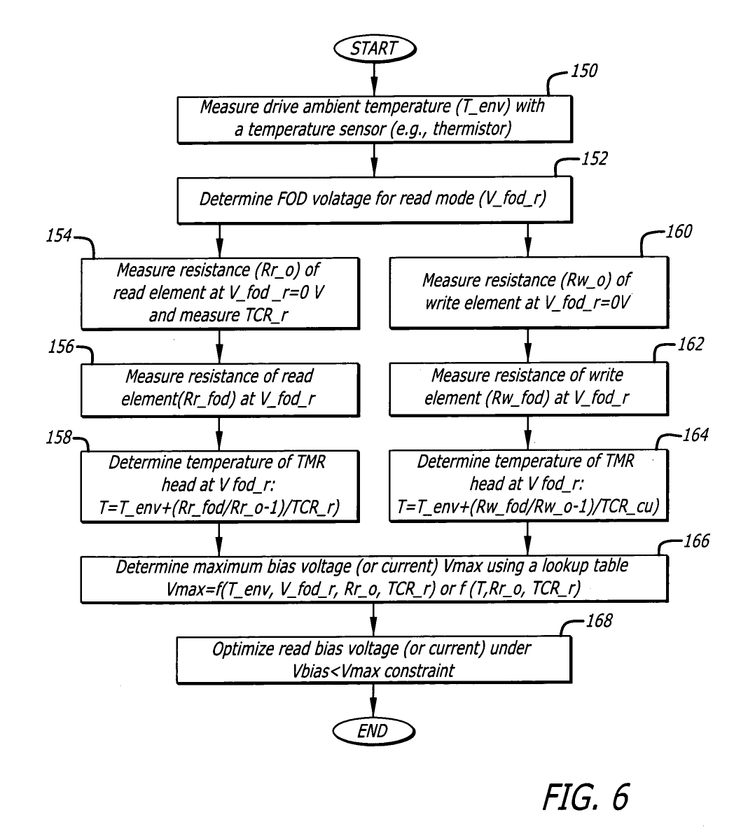

FIG. 6 is a flowchart that shows a process for setting an optimal read bias voltage for the read element. In step 150 the ambient temperature of the drive is measured and set as T_env. The voltage provided to the heater element when the head is in read mode is determined in step 152 and set as V_fod_r. The process can take one of two parallel paths using the read element, path 1, or the write element, path 2.

In path 1 the initial read head resistance Rr_0 is measured and TCR_r is determined in step 154. TCR_r can be determined from the process described in FIG. 4. In step 156, the resistance of the read element Rr_fod is measured after the voltage V_fod_r has been applied to the heater element. In step 158, the temperature of the head is then calculated from the equation:

T=T_{—}env+(Rr_{—}fod/Rr_{—}o−1)/TCR_{—}r) (2)

In path 2, initial write head resistance Rw_0 is measured before a voltage is provided to the heater element in step 160. In step 162 the write head resistance Rw_fod is measured after the voltage V_fod_r has been applied to the heater element. In step 164 the temperature of the head is calculated from the equation:

T=T_{—}env+(Rw_{—}fod/Rw_{—}o−1)/TCR_{—}cu) (3)

In step 166, a maximum bias voltage is determined from the calculated temperature T, determined in either step 158 or step 164. The maximum bias voltage can be determined from an empirically derived look-up table that correlates temperature and maximum bias voltage. In step 168 an optimized read bias voltage is set based on the constraint of the maximum bias voltage. The optimized read bias voltage is set using the heater element as a heat source.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other modifications may occur to those ordinarily skilled in the art.

What is claimed is:

1. A method for determining whether a magneto-resistive head of a hard disk drive is defective for having an undesirable break down voltage, comprising:
applying a voltage to a heater element of a magneto-resistive head;
measuring a write element resistance and a read element resistance;
determining a temperature coefficient of resistance for the read element from the measured read and write element resistances; and,
determining that the magneto-resistive head is defective if the temperature coefficient of resistance exceeds a threshold.

2. The method of claim 1, further comprising varying the voltage to the heater element, measuring a plurality of write and read element resistances and determining the temperature coefficient of resistance from the plurality of write and read element resistances.

3. The method of claim 1, wherein the temperature coefficient of resistance is computed from the following equation:
TCR_{—}r=(Rr_{—}n/Rr_{—}0−1)×TCR_{—}cu/(Rw_{—}n/Rw_{—}0−1)

4. A method for determining a read bias voltage of a magneto-resistive head of a hard disk drive, comprising:
applying a voltage to a heater element of a magneto-resistive head;
measuring a write element resistance;
determining a temperature coefficient of resistance for the read element from the measured write element resistance; and,
determining the read bias voltage from the temperature coefficient of resistance.

5. The method of claim 4, further comprising varying the voltage to the heater element, measuring a plurality of write element resistances and determining the temperature coefficient of resistance from the plurality of write element resistances.

6. The method of claim 5, wherein the temperature coefficient of resistance is computed from the following equation:
T=T_{—}env+(Rw_{—}fod/Rw_{—}o−1)/TCR_{—}cu)

7. A method for determining a read bias voltage of a magneto-resistive head of a hard disk drive, comprising:
applying a voltage to a heater element of a magneto-resistive head;
measuring a read element resistance;
determining a temperature coefficient of resistance for the read element from the measured read element resistance; and,
determining the read bias voltage from the temperature coefficient of resistance.

8. The method of claim 7, further comprising varying the voltage to the heater element, measuring a plurality of read element resistances and determining the temperature coefficient of resistance from the plurality of read element resistances.

9. The method of claim 7, wherein the temperature coefficient of resistance is computed from the following equation:
T=T_{—}env+(Rr_{—}fod/Rr_{—}o−1)/TCR_{—}r)
